(19) United States
(12) Patent Application Publication
(10) Pub. No.: US 2019/0007873 A1
(43) Pub. Date: Jan. 3, 2019

(54) D2D ASSISTED LOAD BALANCING AND HANDOVER TRIGGER

(71) Applicant: NOKIA SOLUTIONS AND NETWORKS OY, Espoo (FI)

(72) Inventors: Ajith KUMAR PARAMESWARN RAJAMMA, TamilNadu (IN); Parijat Bhattacharjee, Bangalore (IN)

(21) Appl. No.: 16/064,902

(22) PCT Filed: May 3, 2016
(86) PCT No.: PCT/EP2016/059860

§ 371 Date: Jun. 21, 2018

(30) Foreign Application Priority Data
Dec. 21, 2015 (IN) 6796/CHE/2015

(51) Int. Cl. H04W 36/00; H04W 36/22; H04W 36/36; H04W 76/14; H04W 76/23

(52) U.S. Cl. CPC H04W 36/00837; H04W 36/22; H04W 76/23; H04W 76/14; H04W 36/36

(57) ABSTRACT

It is provided a method, comprising estimating a potential performance based on information received from a terminal, wherein the information comprises at least an indication that the terminal is served by a first cell, and the potential performance indicates a performance of an apparatus performing the method to be expected if the apparatus were served by the first cell; checking if the potential performance is preferred over an actual performance of the method; providing, to a second cell serving the apparatus, a trigger for a handover to the first cell if the potential performance is preferred over the actual performance.

### FIELD OF THE INVENTION

The present invention relates to an apparatus, a method, and a computer program product related to handover. More particularly, the present invention relates to an apparatus, a method, and a computer program product related to UE assisted handover.

### ABBREVIATIONS

3GPP 3rd Generation Partnership Project
5G 5th generation
BS Base Station
eNB Evolved NodeB
E-UTRAN Evolved UTRAN
HO Handover
IP Internet Protocol
LB Load Balancing
LTE Long Term Evolution
LTE-A LTE Advanced
MBB Mobile Broadband
NFC Near Field Communication
PDCCH Physical Downlink Control Channel
QoS Quality of Service
RB Resource Block
RF Radio Frequency
RRC Radio Resource Control
RLC Radio Link Control
RSRP Reference Signal Received Power
RSSI Received Signal Strength Indicator
RTT Round Trip Time
SINR Signal to Interference and Noise Ratio
SON Self-Optimized Network
TPUT Throughput
TTI Transmission Time Interval
UE User Equipment
VoIP Voice over IP
WiFi Wireless Fidelity
WiMax Worldwide Interoperability for Microwave Access

### BACKGROUND OF THE INVENTION

LTE Advanced (5G) brings D2D functionality for Public Safety and Commercial communication. In D2D communication two devices can directly exchange data under the control of network, without transmitting the data via the network. This new type of communication enables many new opportunities for improving already existing mechanisms in LTE, such as load balancing.

The use of load-balancing (LB) is meant to deliver the extra gain in terms of network performance. LB achieves the extra gain by adjusting the network control parameters in such a way that overloaded cells can offload the excess traffic to low-loaded adjacent cells, whenever available. In a live network high load fluctuations occurs and they are usually accounted for by over-dimensioning the network during planning phase. A SON enabled network, where the proposed SON algorithm monitors the network and reacts to these peaks in load, can achieve better performance by distributing the load among neighbouring cells.

When the loads among cells are not balanced, the block probabilities of heavily loaded cells may be higher, while their neighbouring cells may have resources not fully utilized. In this case load balancing can be conducted to alleviate and even avoid this problem.

There has been a lot of research done on load balancing, which can be classified into two categories: block probability-triggered load balancing, and utility based load balancing. In the first category, the overhead is low because the load balancing is triggered only when the block probability is larger than a certain threshold. However, the overall block probability is not minimized. For the second category, i.e., utility-based load balancing schemes, the performance is better because the load balance and throughput are considered in both cell selection and handover phases. However, the overhead is heavy, because the load of each cell has to be exchanged instantaneously.

### SUMMARY OF THE INVENTION

It is an object of the present invention to improve the prior art.

According to a first aspect of the invention, there is provided an apparatus, comprising estimating means adapted to estimate a potential performance based on information received from a terminal, wherein the information comprises at least an indication that the terminal is served by a first cell, and the potential performance indicates a performance of the apparatus to be expected if the apparatus were served by the first cell; checking means adapted to check if the potential performance is preferred over an actual performance of the apparatus; triggering means adapted to provide, to a second cell serving the apparatus, a trigger for a handover to the first cell if the potential performance is preferred over the actual performance.

The apparatus may further comprise verifying means adapted to verify if the first cell is the same as the second cell; preventing means adapted to prevent the triggering means from providing the trigger if the first cell is the same as the second cell.

The information may be received from the terminal in a device-to-device communication.

The information received from the terminal may comprise one or more parameters comprising at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status. The performance may be a throughput, and the potential performance may be preferred over the actual performance if the potential performance is larger than the actual performance.

The information received from the terminal may comprise a throughput of the terminal and a reference signal received power of the first cell; the estimating means may be adapted to estimate the potential performance as a product of the throughput of the terminal and a ratio of a reference signal received power of the first cell measured by the apparatus and the reference signal received power of the first cell comprised in the received information.

The apparatus may further comprise inhibiting means adapted to inhibit the triggering means from providing the trigger if the potential performance is not larger than the actual performance by at least one of a predetermined factor and a predetermined difference.

The performance may be at least one of a delay, a call drop rate, an error rate, a block error rate, and a roundtrip time, and the potential performance may be preferred over the actual performance if the potential performance is smaller than the actual performance.

The apparatus may further comprise inhibiting means adapted to inhibit the triggering means from providing the trigger if the potential performance is not smaller than the actual performance by at least one of a predetermined factor and a predetermined difference.

According to a second aspect of the invention, there is provided an apparatus, comprising informing means adapted to provide, to a terminal, an identification of a first cell serving the apparatus and an information about one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus.

The informing means may be adapted to provide the identification of the cell and the information about the one or more parameters in a device-to-device communication to the terminal.

The apparatus may further comprise verifying means adapted to verify if the first cell is the same as a second cell, wherein an identification is received from the terminal that the terminal is served by the second cell; preventing means adapted to prevent the informing means from informing the terminal if the first cell is the same as the second cell.

According to a third aspect of the invention, there is provided an apparatus, comprising monitoring means adapted to monitor if a trigger for a handover to a base station different from the apparatus is received from a terminal served by the apparatus; initiating means adapted to initiate the handover regardless of any network performance values available at the apparatus if the trigger is received.

According to a fourth aspect of the invention, there is provided an apparatus, comprising estimating circuitry configured to estimate a potential performance based on information received from a terminal, wherein the information comprises at least an indication that the terminal is served by a first cell, and the potential performance indicates a performance of the apparatus to be expected if the apparatus were served by the first cell; checking circuitry configured to check if the potential performance is preferred over an actual performance of the apparatus; triggering circuitry configured to provide, to a second cell serving the apparatus, a trigger for a handover to the first cell if the potential performance is preferred over the actual performance.

The apparatus may further comprise verifying circuitry configured to verify if the first cell is the same as the second cell; preventing circuitry configured to prevent the triggering circuitry from providing the trigger if the first cell is the same as the second cell.

The information may be received from the terminal in a device-to-device communication.

The information received from the terminal may comprise one or more parameters comprising at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status.

The performance may be a throughput, and the potential performance may be preferred over the actual performance if the potential performance is larger than the actual performance.

The information received from the terminal may comprise a throughput of the terminal and a reference signal received power of the first cell; the estimating circuitry may be configured to estimate the potential performance as a product of the throughput of the terminal and a ratio of a reference signal received power of the first cell measured by the apparatus and the reference signal received power of the first cell comprised in the received information.

The apparatus may further comprise inhibiting circuitry configured to inhibit the triggering circuitry from providing the trigger if the potential performance is not larger than the actual performance by at least one of a predetermined factor and a predetermined difference.

The performance may be at least one of a delay, a call drop rate, an error rate, a block error rate, and a roundtrip time, and the potential performance may be preferred over the actual performance if the potential performance is smaller than the actual performance.

The apparatus may further comprise inhibiting circuitry configured to inhibit the triggering circuitry from providing the trigger if the potential performance is not smaller than the actual performance by at least one of a predetermined factor and a predetermined difference.

According to a fifth aspect of the invention, there is provided an apparatus, comprising informing circuitry configured to provide, to a terminal, an identification of a first cell serving the apparatus and an information about one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus.

The informing circuitry may be configured to provide the identification of the cell and the information about the one or more parameters in a device-to-device communication to the terminal.

The apparatus may further comprise verifying circuitry configured to verify if the first cell is the same as a second cell, wherein an identification is received from the terminal that the terminal is served by the second cell; preventing circuitry configured to prevent the informing circuitry from informing the terminal if the first cell is the same as the second cell.

According to a sixth aspect of the invention, there is provided an apparatus, comprising monitoring circuitry configured to monitor if a trigger for a handover to a base station different from the apparatus is received from a terminal served by the apparatus; initiating circuitry configured to initiate the handover regardless of any network performance values available at the apparatus if the trigger is received.

According to a seventh aspect of the invention, there is provided a method, comprising estimating a potential performance based on information received from a terminal, wherein the information comprises at least an indication that the terminal is served by a first cell, and the potential performance indicates a performance of an apparatus performing the method to be expected if the apparatus were served by the first cell; checking if the potential performance is preferred over an actual performance of the method; providing, to a second cell serving the apparatus, a trigger for a handover to the first cell if the potential performance is preferred over the actual performance.

The method may further comprise verifying if the first cell is the same as the second cell; preventing the providing of the trigger if the first cell is the same as the second cell.

The information may be received from the terminal in a device-to-device communication.

The information received from the terminal may comprise one or more parameters comprising at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status.

The performance may be a throughput, and the potential performance may be preferred over the actual performance if the potential performance is larger than the actual performance.

The information received from the terminal may comprise a throughput of the terminal and a reference signal received power of the first cell; the potential performance may be estimated as a product of the throughput of the terminal and a ratio of a reference signal received power of the first cell measured by the apparatus and the reference signal received power of the first cell comprised in the received information.

The method may further comprise inhibiting the providing of the trigger if the potential performance is not larger than the actual performance by at least one of a predetermined factor and a predetermined difference.

The performance may be at least one of a delay, a call drop rate, an error rate, a block error rate, and a roundtrip time, and the potential performance may be preferred over the actual performance if the potential performance is smaller than the actual performance.

The method may further comprise inhibiting the providing of the trigger if the potential performance is not smaller than the actual performance by at least one of a predetermined factor and a predetermined difference.

According to an eighth aspect of the invention, there is provided a method, comprising providing, to a terminal, an identification of a first cell serving an apparatus performing the method and an information about one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus.

The identification of the cell and the information about the one or more parameters may be provided in a device-to-device communication to the terminal.

The method may further comprise verifying if the first cell is the same as a second cell, wherein an identification is received from the terminal that the terminal is served by the second cell; preventing the informing of the terminal if the first cell is the same as the second cell.

According to a ninth aspect of the invention, there is provided a method, comprising monitoring if a trigger for a handover to a base station different from an apparatus performing the method is received from a terminal served by the apparatus; initiating the handover regardless of any network performance values available at the apparatus if the trigger is received.

The method according to each of the seventh to ninth aspects may be a method for triggering handover.

According to a tenth aspect of the invention, there is provided a computer program product comprising a set of instructions which, when executed on an apparatus, is configured to cause the apparatus to carry out the method according to any of the seventh to ninth aspects. The computer program product may be embodied as a computer readable medium or directly loadable into a computer.

According to an eleventh aspect of the invention, there is provided an apparatus comprising at least one processor, at least one memory including computer program code, and the at least one processor, with the at least one memory and the computer program code, being arranged to cause the apparatus to at least perform at least one of the methods according to any of the seventh to ninth aspects.

According to some example embodiments of the invention, at least one of the following technical effects may be provided:
1. It is provided a method for Mobile Assisted Handover as opposed to a conventional Data Assisted Handover;
2. The UE can understand its own radio environment better and faster than any estimate of it made by a base station;
3. Using a neighbour UE to estimate the impact of a potential HO would lead to an increase in the number of successful HO (leading to a desirable data rate);
4. No need to pass information over X2 interface between eNBs if D2D communication is used;
5. Typically, conventional HOs are triggered when current UE conditions are sub-optimal. The opportunistic mechanism according to the invention allows UE to trigger a HO even when current conditions are optimal, in order to increase at least one of throughput, delay, call drop rate, error rate, block error rate and roundtrip time.

6. The network is evolving towards a distributed architecture—this is a step in that direction where the UE can decide whether to request a HO and to which target BS—this reduces BS signalling, processing and X2 load:
a. This can reduce the X2 latency from the HO decision making process—during the HO, some latency may still be tolerated;
b. Network initiated HO needs a reconfiguration of the HO_offset parameters so that the UE can trigger a HO to the target cell. This signalling can be avoided if the UE takes the decision directly;
7. An additional HO trigger is provided on top of the conventional ones; and
8. A new technology (D2D communication as defined by LTE) or a technology outside LTE is used to improve an existing feature (HO).

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of example embodiments of the present invention which is to be taken in conjunction with the appended drawings, wherein

FIG. 1 shows a method according to an example embodiment of the invention;

FIG. 2 shows an apparatus according to an example embodiment of the invention;

FIG. 3 shows a method according to an example embodiment of the invention;

FIG. 4 shows an apparatus according to an example embodiment of the invention;

FIG. 5 shows a method according to an example embodiment of the invention;

FIG. 6 shows an apparatus according to an example embodiment of the invention;

FIG. 7 shows a method according to an example embodiment of the invention; and

FIG. 8 shows an apparatus according to an example embodiment of the invention.

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

In a cellular network it may happen that a cell is heavily loaded, whereas a neighbor cell may be relatively lightly loaded. From the network operator point of view, it is desirable to move the edge users from the heavily loaded cells to the lightly loaded cell to improve the user performance of the heavily loaded cell. Conventionally, for forcing users connected to heavily loaded cell to a lightly loaded cell there is a need of co-ordination between base stations and exchange of load information between the base stations. Alternate or better ways of load balancing between cells would be useful.

According to some embodiments of the invention, the D2D communication between two UEs is used for computing the network load by at least one of the UEs, in order to trigger device assisted procedures for network load balancing if needed.

For example, in 5G networks, the cell size is expected to be reduced. These cells are called small cells and may be in the order of lOs of meters. So, in such a network most of the devices in neighbouring cells are potential proximity devices (i.e. devices in a distance allowing for D2D communication, also called “proximate”), because the maximum distance between two D2D devices still allowing D2D communication may be up to 250 m. In 5G, D2D is expected to be a standard feature. Thus, most of the devices will be supporting D2D direct communication as part of standard.

However, the invention is not restricted to 5G or to a certain size of the cells. E.g., in conventional networks in dense urban scenarios, the cells sizes are of the order of about 100 m. Even in these cases, some UEs served by another (preferably neighbouring) cell may be proximal to a UE served by a first cell. As another example, even a UE at the edge of a macro cell (size in the order of kilometres) may be proximate to a UE in a neighbouring (or underlaid) other cell.

More in detail, according to some embodiments of the invention, a second UE served by a second cell may use the information on network load received from a first UE served by a first cell to estimate a potential performance if the second UE were served by the first cell. If there is a considerable performance gain, the second UE triggers a handover from the second cell to the first cell. A considerable performance gain may be expected if the difference of the potential performance and the actual performance is larger than a predefined threshold if a larger value of the performance is preferred (preferably the threshold is positive in this case), or if the difference of the potential performance and the actual performance is smaller than a predefined threshold if a smaller value of the performance is preferred (preferably the threshold is negative in this case). Alternatively, or in addition, the ratio of the potential performance and the actual performance may be considered. A considerable performance gain may be expected if the ratio is larger than 1 (if a larger value of the performance is expected) or smaller than 1 (if a smaller value of the performance is preferred). Preferably, a factor threshold different from 1 is applied.

The handover mechanism as such may be conventional. Note that application distinguishes “triggering a handover” and “initiating a handover”. “Triggering a handover” means a request to the network to attempt to perform a handover. Performing the handover (or attempting to perform the handover, if the handover is not successful) starts by “initiating the handover”. Thus, both UE and network can “trigger a handover”, while only the network can “initiate the handover” based on a trigger from UE or network.

In some embodiments of the invention, the second cell receiving the trigger of a handover will not check parameters which are taken into account for a network initiated handover for initiating the handover. I.e., the network considers that the trigger provided by the UE is reliable to ensure a successful handover to the first cell with a high probability.

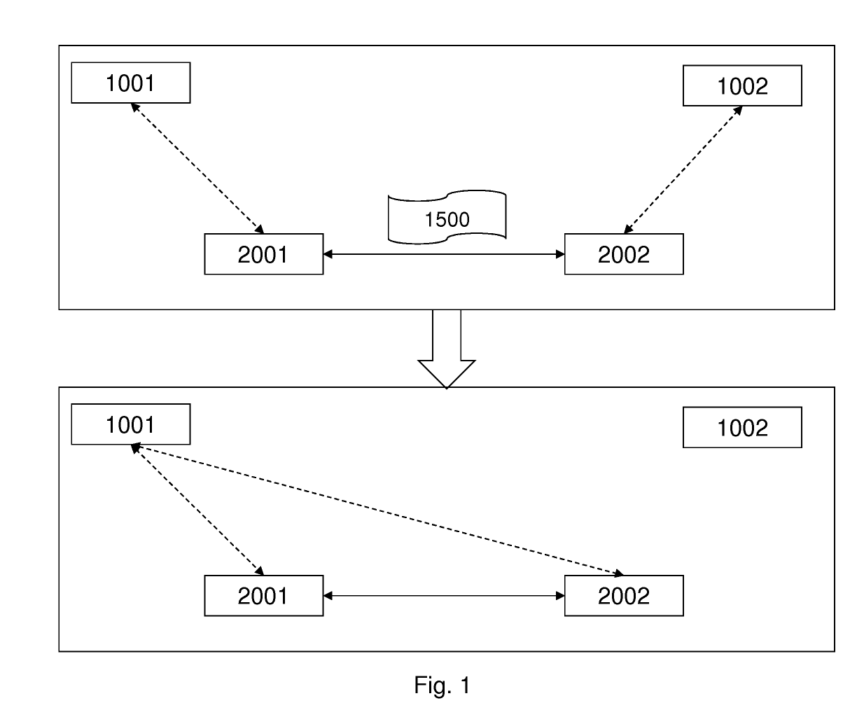

An example of a method according to an embodiment of the invention is described hereinafter with reference to FIG. 1, wherein the performance to be optimized is a throughput:

Assume that two UEs 2001, 2002 from neighboring cells form a D2D pair (i.e. are proximate to each other and set up a D2D communication): UE1 2001 served by BS1 1001 (cell 1) and UE2 2002 served by BS2 1002 (cell 2). E.g., UE1 2001 and UE2 2002 may be at the respective cell edge of their cell. The base stations BS1 1001 and BS2 1002 may be eNBs. In FIG. 1, serving is indicated by a dashed line.

The UEs 2001, 2002 exchange load metrics 1500 (in general: information, based on which a load in the serving cell may be estimated) with its peer UE such as SINR from the serving cell and average data throughput from the serving cell. In some embodiments of the invention, it is sufficient that one UE (e.g. UE1 2001) provides the load metrics 1500 (load information) to the other UE (in the example: UE2 2002). In FIG. 1, the exchange of the load metrics 1500 is indicated by a solid arrow. The load metrics 1500 may be exchanged by D2D communication.

At least one of the UEs (e.g. UE2 2002) then computes the expected throughput under the assumption that it makes a handover from its serving cell (cell 2 of eNB2 1002) to the other cell (cell 1 of eNB1 1001). For this computation, UE2 2002 uses the load information received from UE1 2001 of cell 1. If there is a significant throughput gain expected from being served by the neighboring cell (cell 1 of eNB1 1001) then UE2 2002 (i.e., the UE with lower average throughput) triggers a HO to the neighboring cell, i.e. to cell 1 of eNB 1001. If the handover is successful, UE2 2002 is then served by eNB1 1001 (see bottom part of FIG. 1). UE1 2001 and UE2 2002 may or may not maintain their D2D communication.

In detail,
UE1 2001 is served by BS1 1001 and measures RSRP (UE1, BS1) and throughput X (UE1, BS1).
UE2 2002 is served by BS2 1002 and measures throughput X (UE2, BS2). In addition, it measures RSRP (UE2, BS1), i.e. the power of the reference signal of BS1 1001, which does not serve UE2 2002. UE2 2002 may measure RSRP (UE2, BS1) because cell 1 and cell 2 are close to each other (e.g. neighbours). Furthermore, UE2 2002 may measure RSRP (UE2, BS2).
UE1 2001 provides RSRP (UE1, BS1) and throughput X (UE1, BS1) to UE2 2002 using the D2D communication.
Optionally, UE2 2002 may check if X (UE2, BS2) is considerably smaller than X (UE1, BS1). If his is not the case, the method may stop.
UE2 2002 estimates its throughput under the assumption that it were served by BS1 1001 based on the information (RSRP, X) received from UE1 2001 and its own measurements. E.g., the potential throughput (estimated throughput) Xest may be calculated as:

Xest=X (UE1, BS1)*RSRP (UE2, BS1)/RSRP (UE1, BS1)
UE2 2002 compares the potential throughput Xest with its actual throughput X (UE2, BS2). If a significant gain is to be expected from a handover from BS2 1002 to BS1 1001 (e.g. Xest/X (UE2, BS2)>k with k being a predefined factor>1), UE2 2002 will trigger BS2 1002 to initiate handover to BS1 1001.

While in the above example, average throughput is exchanged between the UEs 2001, 2002, the metrics exchanged between the D2D UEs of two cells is not limited to average throughput. The UEs may exchange different metrics, e.g. depending on the QoS and service type that may be used for the load estimation of the target cell irrespective of the traffic nature of the UE. This may be relevant e.g. in a case where one UE performs a service requiring low throughput (e.g. VoIP) while the other performs a service with high troughput (e.g. MBB).

The metric here may include both physical and higher layer metrics. The physical layer metric may include, but not limited to, RSSI, interference fluctuations, SINR, FER, RB usage. The higher layer metrics may include, but not limited to, block error rates, RLC packet segmentation percentage, packet error rate at the application layer, RTT.

In some embodiments of the invention, irrespective of the UE's QoS class, the UE measures the RB usage in a network and passes that information to the other UE. A UE can determine its RB allocation via the scheduling grant send by physical downlink control channel (PDCCH). Any RBs which are not allocated to the UE may be either not scheduled or scheduled to other UEs. The information on number of RBs allocated in the serving cell is passed to the other UE. By determining how many RBs are being used or scheduled of the total possible RBs available from the target cell, a UE can estimate the total load on the target cell.

The UE may measure the total received power (in terms of RSSI) on a per RB basis. For each RB it computes the SINR for the feedback to eNB for enabling frequency selective scheduling (FSS). Thus the UE is able to determine whether an RB is allocated by the cell to transmit data to another UE or not. The UE, irrespective of its QoS class, may estimate the percent of RB usage in a cell and pass this information to the other UE which is D2D paired. If this percentage is lower in the other cell than its own cell then the UE may trigger a handover.

The UE may perform the load estimation by the reported buffer status to the eNB along with the data rate at which the UE is scheduled by the eNB. An estimate of average buffer status over a period of time can be used in the case of non-full-buffer users. The UE's reported buffer size and the corresponding grants from eNB may be communicated via the D2D link to the other D2D UE. The other D2D UE can compare these values with its own buffer status report and the grants from it's serving eNB. An estimation and comparison of the load of the target cell may be made using these parameters.

According to some embodiments of the invention the RLC layer metrics may also be used. If the load is high, the RLC segments packets to small sizes and transmits them over multiple TTIs. Hence, in these embodiments, the number and size of packet segmentations done may give an estimation of approximate load. A D2D UE may pass these information to its D2D pair on the other cell to make a comparison of load of the target cell with respective the UE's serving cell.

Also, in some embodiments of the invention, for some traffic types the UE may use the round trip time (RTT) of transmissions or the application layer packet error rate. If these two parameters are high then the related load in the cell may be high. Hence, in some embodiments of the invention, this metric may be provided from one UE to the other UE via D2D link.

So, among the D2D pair one UE may have one type of traffic and another UE may have another type of traffic. By exchanging channel conditions and some relevant traffic related load estimation parameters as given above, the other UE can estimate the load in the target cell and can make decision based on the RF conditions.

The handover trigger from UE2 2002 may be added to the existing list of UE handover triggers in the 3GPP standard documents.

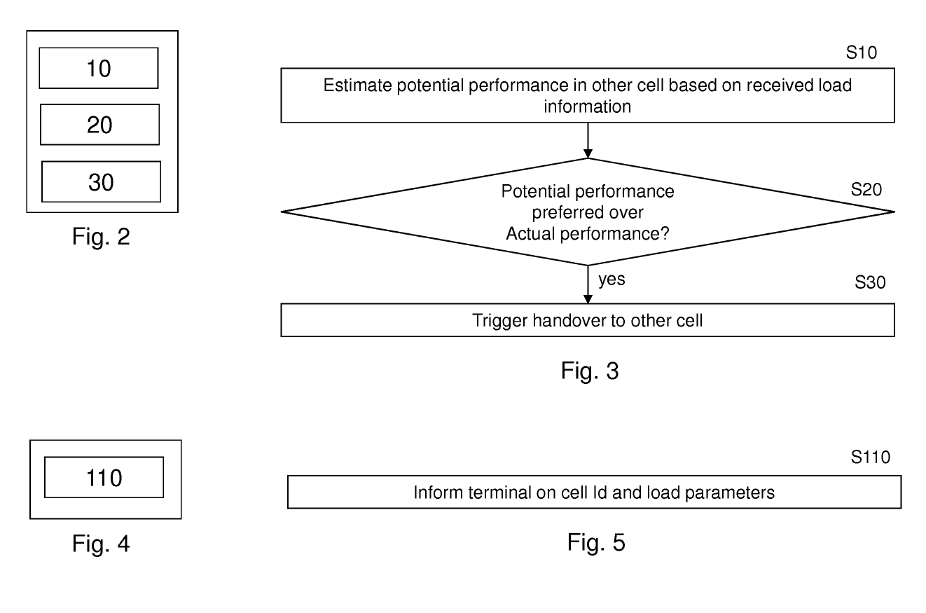

FIG. 2 shows an apparatus according to an example embodiment of the invention. The apparatus may be a terminal such as a UE, or an element thereof. FIG. 3 shows a method according to an example embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises estimating means 10, checking means 20, and triggering means 30. The estimating means 10, checking means 20, and triggering means 30 may be an estimating circuitry, a checking circuitry, and a triggering circuitry, respectively.

The estimating means 10 estimates a potential performance (S10). The estimation is based on information (load information) received from a terminal. The information comprises an indication that the terminal is served by a first cell. The potential performance indicates a performance of the apparatus to be expected if the apparatus were served by the first cell although the apparatus is actually served by a second cell (i.e., an estimated performance).

The checking means 20 checks if the potential performance is preferred over an actual performance of the apparatus (S20). Depending on the actual parameter represented by the “performance”, the potential performance may be preferred if it is higher than the actual performance (e.g. in case the performance is throughput), or the potential performance may be preferred if it is smaller than the actual performance (e.g. in case the performance is at least one of a delay, a call drop rate, an error rate, a block error rate, and a roundtrip time).

Preferably, in the former case, the checking means checks if the potential performance is significantly larger than an actual performance of the apparatus. “Significantly larger” means, as non-limiting examples, larger by a predetermined factor (>1) or by a predetermined difference (>0), depending on if the comparison is made on a ratio or a difference of the potential performance and the actual performance. Preferably, in the latter case, the checking means checks if the potential performance is significantly smaller than an actual performance of the apparatus. “Significantly smaller” means, as non-limiting examples, smaller by a predetermined factor (<1) or by a predetermined difference (<0), depending on if the comparison is made on a ratio or a difference of the potential performance and the actual performance. Thus, frequent handovers between cells of approximate equal loads may be avoided.

If the potential performance is preferred over the actual performance (S20=“Yes”), the triggering means 30 provides, to the second cell serving the apparatus, a trigger for a handover to the first cell (S30).

FIG. 4 shows an apparatus according to an example embodiment of the invention. The apparatus may be a terminal such as a UE, or an element thereof. FIG. 5 shows a method according to an example embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises informing means 110. The informing means 110 may be an informing circuitry.

The informing means 110 provides, to a terminal, an identification of a first cell serving the apparatus (S110). In addition, the informing means provides, to the terminal, information about a load in the cell serving the apparatus (S110). The information may comprise one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus. Preferably, the identification and the information are transmitted by a D2D communication.

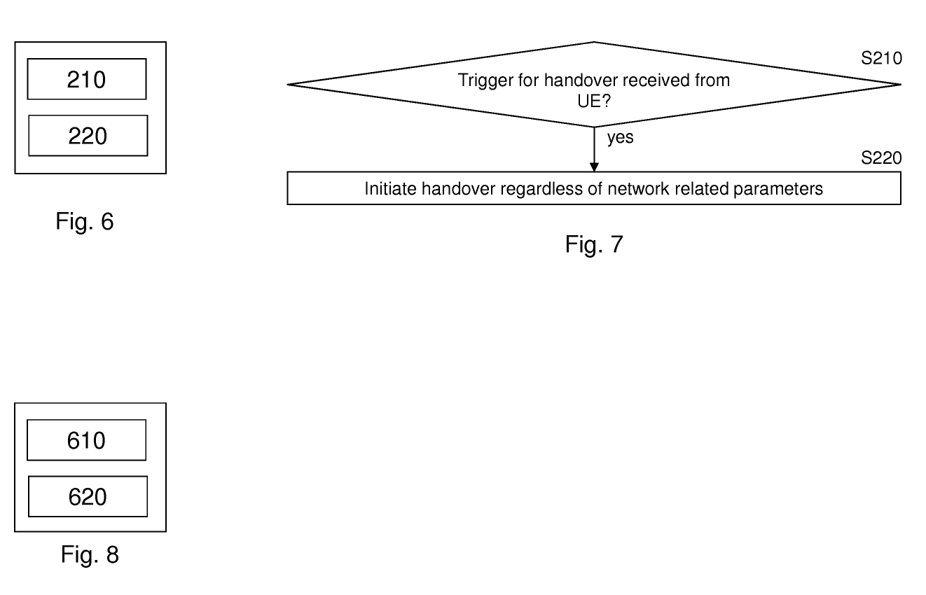

FIG. 6 shows an apparatus according to an example embodiment of the invention. The apparatus may be a base station such as a NodeB or eNodeB, or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises monitoring means 210 and initiating means 220. The monitoring means 210 and initiating means 220 may be an monitoring circuitry and an initiating circuit, respectively.

The monitoring means 210 monitors if a trigger for a handover to a base station different from the apparatus is received from a terminal served by the apparatus (S210).

If the trigger is received (S210=“Yes”), the initiating means 220 initiates the handover regardless of any network performance values available at the apparatus (S220).

FIG. 8 shows an apparatus according to an example embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 3, 5, and 7 and related description.

Embodiments of the invention are described, wherein the information of the load of one cell is provided to a UE in another cell by D2D communication, i.e. without transmitting this information via the network. However, in some embodiments of the invention, the information of the load may be transmitted fully or partly via the network. In these embodiments, there is still the advantage that the decision on HO may be met by the UE such that the probability of a successful handover is higher than in a case where the network meets the decision on HO.

In some embodiments of the invention, a D2D communication over a wireless radio link different from that defined by LTE may be employed. For example, the D2D communication may be performed in a spectrum outside LTE, and/or using another protocol than LTE, etc. The D2D communication may be even performed via a wire or a wired network. Any way allowing a communication between the UEs is feasible according to some embodiments of the invention. Non-limiting examples of non-LTE D2D communications may be based on Bluetooth, NFC, WiFi Direct, and WiMax.

In the embodiments described above, it is assumed that the involved UEs are in different cells. However, in some embodiments of the invention, it is not checked if the UEs are in different cells. In these embodiments, it is very unlikely that the expected performance will be considerably higher than the actual performance. Hence, a handover will very likely not be triggered although a check for different cells was not performed. Besides, the network may discard a trigger for a “handover” from one cell to the same cell.

On the other hand, if a check is made whether or not the cells of the involved UEs are different, it may be prevented to provide the trigger for handover if the cells are the same. In addition, in this case, one may prevent one or both of estimating the expected performance and checking if the expected performance is considerably higher than the actual performance.

The UEs may exchange the information on the load e.g. on a regular basis, or one UE may provide the information upon request of another UE. E.g., the one UE may issue such a request if its actual performance is lower than a certain threshold, wherein the certain threshold is preferably higher than a corresponding threshold for a network initiated handover.

In some embodiments of the invention, one UE may evaluate the load information from more than one UE of a same cell. Thus, it gets more significant information on the load in the other cell. E.g., in some of these embodiments, it may trigger a handover if its actual performance is significantly worse than the lowest expected performance respectively obtained from the more than one UE. In some of these embodiments, it may trigger a handover if its actual performance is significantly worse than the average expected performance obtained from averaging the expected performances obtained from the load information from the more than one UE.

Embodiments of the invention are described where the two cells serving the UEs are neighbors. However, the invention is not limited to neighboring cells. If the load information is (at least partly) transmitted by D2D communication it is sufficient that the involved UEs are proximate to each other (i.e., close enough to set up the D2D communication). For the estimation of the expected performance, the UE should preferably take into account the relative signal strengths from both cells (see the ratio of RSSP values in the example of FIG. 1). Thus, the cells may be neighboring or not.

The cells considered for the handover trigger may be cells of different physical base stations or cells of the same physical base station. Throughout the present application, the term “base station” is used as the logical entity serving one cell.

Embodiments of the invention are described, wherein throughput is used as a performance metrics to be optimized. However, in some embodiments of the invention, instead or in addition to throughput, other performance metrics may be optimized. Such performance metrics may be e.g. one or more of delay, call drop rate, error rate, block error rate, and roundtrip time. For example, if a lower value of the respective performance metrics is preferred (e.g. in case of delay, call drop rate, error rate, block error rate, and roundtrip time), instead of the ratio RSRP (UE2, BS1)/RSRP (UE1, BS1) used to estimate the throughput in the example above, its reciprocal RSRP (UE1, BS1)/RSRP (UE2, BS1) may be applied correspondingly.

If plural performance metrics are optimized, there may be a hierarchy such that a second performance metrics is only optimized if there are plural options to optimize the first performance metrics. Alternatively, a new performance indicator generated based on two or more of the original performance indicators may be optimized.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

Some example embodiments of the invention may be applied to a 3GPP network (e.g. LTE, LTE-A, or a 5G network), as described hereinabove. However, some example embodiments of the invention may be applied to any kind of network wherein the handover procedure is initiated by the network but terminals may exchange information of network performance.

A terminal may be any kind of terminal which may attach to the respective network. E.g., a terminal may be a UE, a D2D device, a device of a machine-type communication, a laptop, a smartphone, a mobile phone etc.

According to the above description, it should thus be apparent that example embodiments of the present invention provide, for example a terminal such as a UE or a D2D device, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example a base station such as a NodeB or an eNodeB, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques, means, entities, units, devices, or methods include, as non-limiting examples, implementations as hardware, software, firmware, special purpose circuits or logic, general purpose hardware or controller or other computing devices, a virtual machine, or some combination thereof.

It should be noted that the description of the embodiments is given by way of example only and that various modifications may be made without departing from the scope of the invention as defined by the appended claims.

1. An apparatus comprising at least one processor and at least one memory including computer instructions, when executed by the at least one processor, cause the apparatus to:
estimate a potential performance based on information received from a terminal, wherein the information comprises at least an indication that the terminal is served by a first cell, and the potential performance indicates a performance of the apparatus to be expected if the apparatus were served by the first cell;
check if the potential performance is preferred over an actual performance of the apparatus; and
provide, to a second cell serving the apparatus, a trigger for a handover to the first cell if the potential performance is preferred over the actual performance.

2. The apparatus according to claim 1, further causing the apparatus to:
verify if the first cell is the same as the second cell; and
prevent the apparatus from providing the trigger if the first cell is the same as the second cell.

3. The apparatus according to claim 1, wherein the information is received from the terminal in a device-to-device communication.

4. The apparatus according to claim 1, wherein:
the information received from the terminal comprises one or more parameters comprising at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status.

5. The apparatus according to claim 1, wherein the performance is a throughput, and the potential performance is preferred over the actual performance if the potential performance is larger than the actual performance.

6. The apparatus according to claim 5, wherein:
the information received from the terminal comprises a throughput of the terminal and a reference signal received power of the first cell; and
wherein causing the apparatus to estimate comprises causing the apparatus to estimate the potential performance as a product of the throughput of the terminal and a ratio of a reference signal received power of the first cell measured by the apparatus and the reference signal received power of the first cell comprised in the received information.

7. The apparatus according to claim 1, further causing the apparatus to:
inhibit the apparatus from providing the trigger if the potential performance is not larger than the actual performance by at least one of a predetermined factor and a predetermined difference.

8. The apparatus according to claim 1, wherein the performance is at least one of a delay, a call drop rate, an error rate, a block error rate, and a roundtrip time, and the potential performance is preferred over the actual performance if the potential performance is smaller than the actual performance.

9. The apparatus according to claim 8, further causing the apparatus to:
inhibit the apparatus from providing the trigger if the potential performance is not smaller than the actual performance by at least one of a predetermined factor and a predetermined difference.

10. An apparatus comprising at least one processor and at least one memory including computer instructions, when executed by the at least one processor, cause the apparatus to:
provide, to a terminal, an identification of a first cell serving the apparatus and an information about one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus.

11. The apparatus according to claim 10, wherein the apparatus is adapted to provide the identification of the cell and the information about the one or more parameters in a device-to-device communication to the terminal.

12. The apparatus according to claim 10, further causing the apparatus to:
verify if the first cell is the same as a second cell, wherein an identification is received from the terminal that the terminal is served by the second cell; and
prevent the apparatus from informing the terminal if the first cell is the same as the second cell.

13. An apparatus comprising at least one processor and at least one memory including computer instructions, when executed by the at least one processor, cause the apparatus to:
monitor if a trigger for a handover to a base station different from the apparatus is received from a terminal served by the apparatus; and
initiate the handover regardless of any network performance values available at the apparatus if the trigger is received.

14. A method, comprising:
estimating a potential performance based on information received from a terminal, wherein the information comprises at least an indication that the terminal is served by a first cell, and the potential performance indicates a performance of an apparatus performing the method to be expected if the apparatus were served by the first cell;
checking if the potential performance is preferred over an actual performance of the method; and
providing, to a second cell serving the apparatus, a trigger for a handover to the first cell if the potential performance is preferred over the actual performance.

15-22. (canceled)

23. A method, comprising:
providing, to a terminal, an identification of a first cell serving an apparatus performing the method and an information about one or more parameters, wherein the one or more parameters comprise at least one of a signal to interference and noise ratio, a throughput, a delay, a scheduling opportunity, a call drop rate, an error rate, a reference signal received power, a total received power, a block error rate, a packet segmentation, a roundtrip time, a resource block utilization, and a buffer status, and the one or more parameters are based on at least one measurement performed by the apparatus.

24-25. (canceled)

26. A method, comprising:
monitoring if a trigger for a handover to a base station different from an apparatus performing the method is received from a terminal served by the apparatus; and
initiating the handover regardless of any network performance values available at the apparatus if the trigger is received.

27-28. (canceled)
